(19) United States
(12) Patent Application Publication
(10) Pub. No.: US 2017/0071035 A1
(43) Pub. Date: Mar. 9, 2017

(54) METHOD FOR CONTROLLING COOKER

(71) Applicant: LG ELECTRONICS INC., Seoul (KR)

(72) Inventor: Eunmi SHIN, Seoul (KR)

(21) Appl. No.: 15/254,047

(22) Filed: Sep. 1, 2016

(30) Foreign Application Priority Data
Sep. 3, 2015 (KR) 10-2015-0125168

(51) Int. Cl. H05B 6/64; A23L 5/10; H05B 6/68; A47J 36/32

(52) U.S. Cl. CPC H05B 6/6435; A47J 36/32; A23L 5/15; H05B 6/687; A23V 2002/00

(57) ABSTRACT

A method for controlling a cooker is provided that may include receiving via a user input a selection of a menu in which one of a manual cooking mode or an automatic cooking mode may be selected and a cooking start signal, determining via the controller whether a type of dish to be cooked requires a user operation in which, when the automatic cooking mode is selected, whether an input type of dish to be cooked requires a manual user operation during cooking is determined and performing via the controller a user operation mode in which, when it is determined, in the determining of whether the type of dish to be cooked requires a user operation, that the type of dish to be cooked requires the manual user operation, the user is informed of a time point at which a predetermined user operation has to be performed.

### CROSS-REFERENCE TO RELATED APPLICATION(S)

This application claims priority under 35 U.S.C. §119 and 36 U.S.C. §365 to Korean Patent Application No. 10-2015-0125168, filed in Korea on Sep. 3, 2015, whose entire disclosure is, hereby incorporated by reference.

### BACKGROUND

1. Field

A method for controlling a cooker is disclosed herein.

2. Background

Cookers are one type of home appliance provided in a kitchen space to cook or heat food or other items. The cookers may be classified as a microwave oven and an oven, for example, depending on a heat source for heating food and may also be classified as a built-in type, a standing type, and a wall-mounted type, for example, depending on an installation.

The microwave oven is a kitchen utensil that cooks or heats food or other items by emitting high-frequency waves in an inner space in which food is disposed or provided and heats the food by the high-frequency waves. The oven is a kitchen utensil that cooks or heats food or other items by emitting heat from a heater, or a burner, for example to an inner space in which food is disposed or provided and heats the food by the heat.

A cooker includes a main body that forms an exterior thereof, a cavity which is a space in which food is cooked in an inner space of the main body, an electronic component compartment disposed or provided at one side of the cavity and having a plurality of electronic components installed to cook food, and a heat source to heat food disposed or provided inside of the cavity. For the heat source, a magnetron that emits high-frequency waves to heat food may be simultaneously or separately configured with a heater, or a burner, for example, that emits heat to heat food.

In addition, the cooker may set a plurality of dishes preferred by users as dishes for “automatic cooking” and produce the dishes by programming corresponding algorithms in advance for user convenience. A suitable algorithm is set depending on types of dishes to be cooked for “automatic cooking”. The “automatic cooking” is a function of performing cooking according to a set algorithm including a preset or predetermined cooking temperature and cooking time, for example, when a user just selects and inputs a predetermined key in a key input unit.

In addition, when the user selects a desired cooking function from a cooking menu, a function of displaying a selected function and cooking time on a display disposed or provided at a main body may be provided so that the user may immediately recognize the selected function and cooking time. Also, when cooking is finished, a function of generating an alarm through a speaker may be provided to inform the user that the cooking is finished.

The “automatic cooking” function only provides suitable cooking temperature and cooking time, and when food being cooked needs to be turned over or a cooking ingredient needs to be added, the user has to turn over the food being cooked or add the cooking ingredient after directly checking a cooking time and stopping a cooker. Consequently, when a separate operation by the user is required during cooking to ensure quality of cooking, a function of informing the user of a time point at which an operation of turning over food being cooked or adding a cooking ingredient should be performed is required.

### BRIEF DESCRIPTION OF THE DRAWINGS

Embodiments will be described in detail with reference to the following drawings in which like reference numerals refer to like elements, and wherein:

FIG. 1 is a perspective view illustrating an exterior of a microwave oven having a general display;

FIG. 2 is a front view illustrating front surface of a display according to an embodiment;

FIG. 3 is a block diagram of a control apparatus of a cooker according to an embodiment;

FIG. 4 is a flowchart of a method for controlling a cooker according to an embodiment; and

FIG. 5 is a flowchart illustrating a method for controlling a user operation mode of FIG. 4.

### DETAILED DESCRIPTION

Reference will now be made in detail to embodiments, examples of which are illustrated in the accompanying drawings. The embodiments may, however, be embodied in many different forms and should not be construed as being limited o the embodiments set forth herein; rather, alternative embodiments falling within the spirit and scope can easily be derived through adding, altering, and removing, and will fully convey the concept to those skilled in the art.

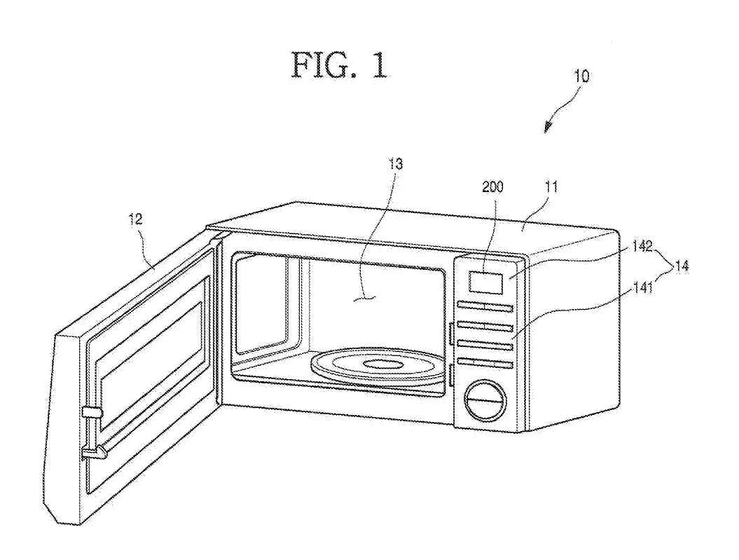

In addition, hereinafter, a microwave oven 10 of FIG. 1 will be described as an embodiment for convenience of description and understanding. However, a method for controlling a cooker according to an embodiment is not limited to the microwave oven 10 and is applicable to various cooking apparatuses, such as an oven that heats and cooks food, by a heat source.

FIG. 1 is a perspective view illustrating an exterior of a microwave oven having a general display. Referring to FIG. 1, generally, the microwave oven 10 may include a main body 11 formed in a substantially rectangular parallelepiped shape and having a cooking compartment 13, a door 12 that opens and closes the cooking compartment 13, and a front panel 14 that forms a portion of a front surface of the microwave oven 10. A manipulation unit or panel 141 having one or more manipulation key with which a user may select a desired cooking function or type of dish to be cooked or manipulate a strength of a heat source or a time for cooking to begin or end, and a display unit or device 142 having a display 200 showing a cooking function selected by the user, a cooking time, and a cooking, condition may be formed at the front panel 14.

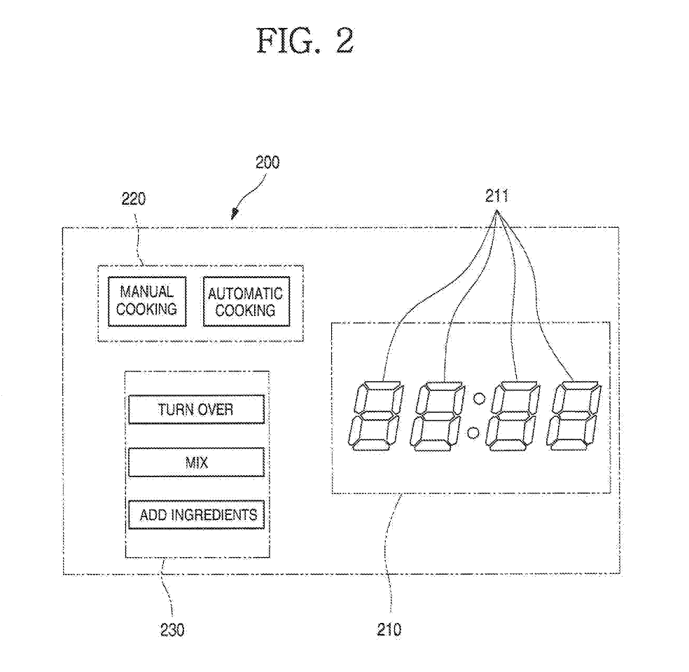

FIG. 2 is a front view illustrating a front surface of a display according to an embodiment. Referring to FIG. 2, the display 200 may include a time output unit or output 210 that outputs a cooking time, an operation mode output unit or output 220 that shows an operation mode classified as manual cooking and automatic cooking, and an operation instruction output unit or output 230 which is able to instruct a user to perform an operation when a direct manual user operation is required during an automatic cooking mode.

The time output 210 may be configured to display a cooking time with a plurality of 7-segments 211. In addition, the time output 210 may display a total cooking time according to a manual cooking setting by the user or a total cooking time preset or predetermined according to a type of dish to be cooked when the user selects automatic cooking. Also, the time output 210 may be configured to continuously output a cooking time being counted down to allow the user to recognize a time remaining until cooking is finished.

In addition, the operation mode output 220 may be configured to output, using letters or drawings, whether an operation mode input through the manipulation panel 141 by the user is the manual cooking mode or the automatic cooking mode to allow the user to recognize an operation mode. Further, the operation instruction output 230 may be configured to output a required operation, using letters or drawings, to guide a user operation when a type of dish to be cooked requires a manual user operation during the automatic cooking mode. Manual user operations that may be performed during the automatic cooking mode may include turning over food being cooked, adding a cooking ingredient, and mixing cooking ingredients, for example.

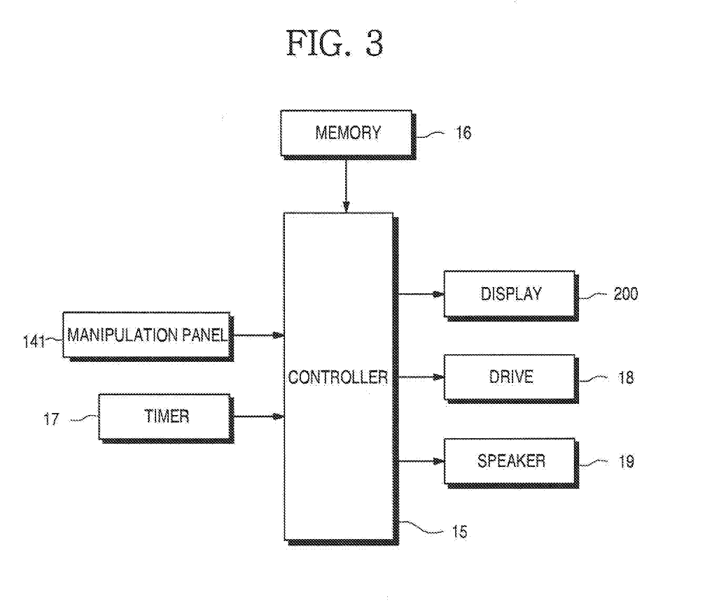

FIG. 3 is a block diagram of a control apparatus of a cooker according to an embodiment. Referring to FIG. 3, the microwave oven 10 according to an embodiment may include a control unit or controller 15 having a program for operating the microwave embedded therein and that outputs various types of calculations and control signals required for the operation, a timer 17 that counts down time, a memory 16 that stores operation algorithm data according to types of dishes to be cooked and cooking functions, a driving unit or drive 18 that performs cooking according to instructions from the controller 15 and a speaker 19 that outputs a sound which may be recognized by a user.

When the user inputs a desired cooking function and type of dish to be cooked through the manipulation panel 141, the manipulation panel 141 may transmit an input signal to the controller 15. In addition, the timer 17 may continuously count down time and transmit a signal to the controller 15.

The controller 15 may compare the signal input from the manipulation panel 141 with preset data in the memory 16 and allow an operation corresponding to the input signal to be performed. More specifically, the controller 15 may output a cooking function and a cooking time for example, corresponding to the signal input from the manipulation panel 141 through the display 200. In addition, the drive 18 may be operated according to an operation algorithm stored in the memory 16 to perform cooking. In addition, a cooking time output through the display 200 may be controlled to be counted down and output according to a signal input from the timer 17.

In addition, the controller 15 may control an operation of the speaker 19 according to a preset or predetermined operation algorithm in the memory 16 to output a sound. The operation of the speaker 19 may be performed at a time point at which a user operation is required among when cooking begins, when cooking is finished, and during automatic cooking.

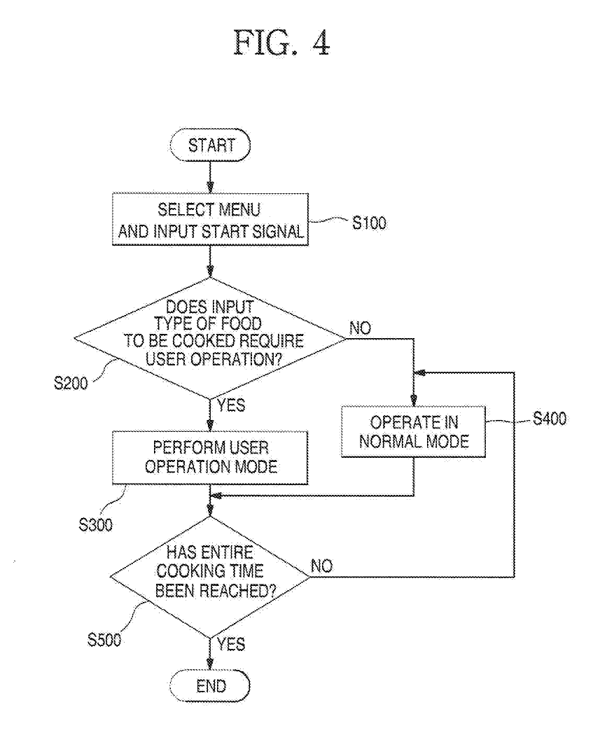

FIG. 4 is a flowchart of a method for controlling a cooker according to an embodiment. To cook food or other items, a user may select a menu and input a start signal (S100) by manipulating the manipulation panel 141 to select a desired cooking function and input a start signal of the microwave oven 10.

The user may manipulate the manipulation panel 141 to select a desired cooking function. That is, the user may manually manipulate or select a type of dish to be cooked, a cooking time, and a cooking temperature, for example, or select a type of dish to be cooked in an automatic cooking mode. The cooking function selected by the user may be output through the display 200 so that the user may recognize the selected cooking function, and after checking the selected cooking function, the user may manipulate the manipulation panel 141 to input a cooking start signal.

When the cooking start signal is input, the controller 15 may determine whether the input cooking function is the automatic cooking mode or the manual cooking mode. In addition, when the automatic cooking mode has been input, the controller 15 may determine whether an input type of dish to be cooked requires a user operation during cooking (S200). That is, by checking a preset or predetermined operation algorithm in the memory 16, determining whether a type of dish to be cooked requires a user operation in which whether a user operation is preset or predetermined for an operation algorithm corresponding to the input type of dish to be cooked is determined may be performed.

When it is determined, in the determining of whether a type of dish to be cooked requires a user operation, that a user operation is required, the controller 15 may perform a user operation mode (S300) in which the user is informed that a manual user operation time point has been reached when a preset manual user operation time point is reached during cooking.

In the determining of whether a type of dish to be cooked requires a user operation (S200), when it is determined to be in the manual cooking mode or a user operation is not preset or predetermined for the operation algorithm corresponding to the input type of dish to be cooked the controller 15 may perform a typical normal operation of the microwave oven 10 (S400) in which the drive 18 is operated during a preset or predetermined amount of cooking time according to a cooking time or a type of dish to be cooked input by the user.

In addition, the controller 15 may perform determining whether cooking is finished in which whether a cooking finished time has been reached (S500) after the performing of a user operation mode (S300) is finished or after the operating in a normal mode (S400). After the performing of a user operation mode (S300) is finished the controller 15 may determine whether a time counted down by the timer 17 has reached the cooking finished time. In addition, the operating in a normal mode (S400) is performed when the cooking finished time has not been reached, and the operation of the drive 18 is stopped when the cooking finished time has been reached.

In addition, after the operating in a normal mode (S400) is performed, whether the cooking finished time has been reached may be determined, and when the cooking finished time has not been reached, the operating in a normal mode (S400) may be continuously performed until the cooking finished time is reached (S500).

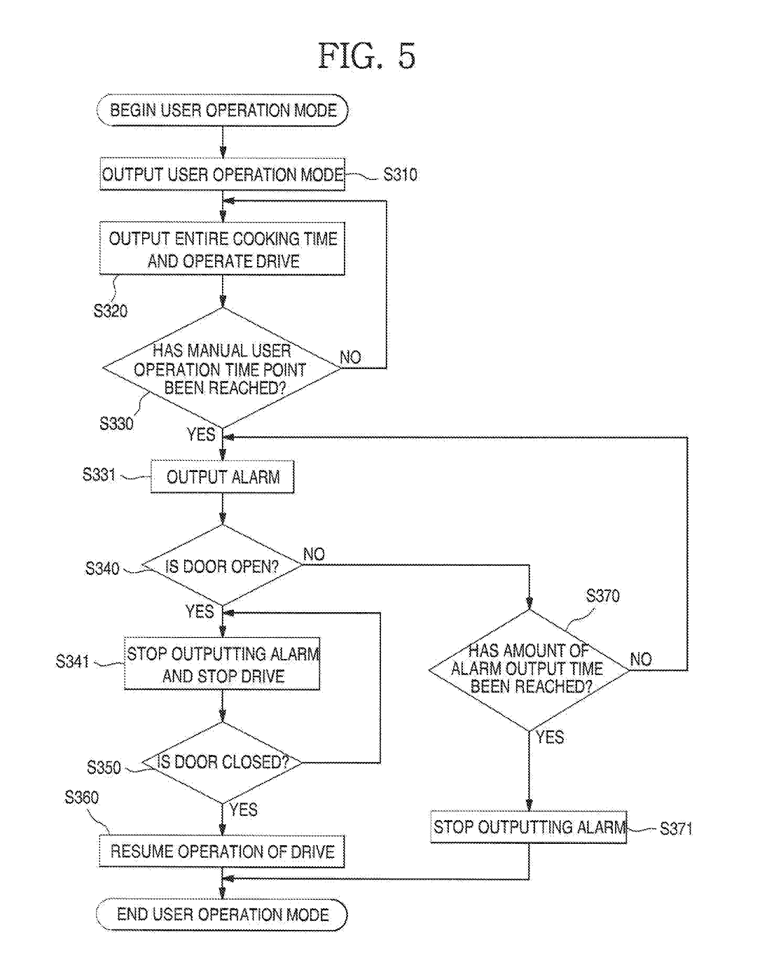

FIG. 5 is a flowchart illustrating a method for controlling a user operation mode of FIG. 4. Referring to FIG. 5, when the performing of a user operation mode (S300) begins, the display 200 may output the operation instruction output 230 so that the user may recognize an operation in the user operation mode. In addition, a time remaining until the manual user operation time point may be output through the time output 210, so that the user may recognize the manual user operation time point in advance.

The operation instruction output 230 and the time output 210 may flicker for a predetermined amount of time and then continuously output a value so that the user may more easily recognize the operation in the user operation mode and the time remaining until the manual user operation time point (S310). In addition, after the time remaining until the manual user operation time point is output from the time output 210 for a predetermined amount of time, the controller 15 may output an entire cooking time through the time output 210 and operate the drive 18 to begin cooking. The entire cooking time output from the time output 210 may be continuously counted down upon beginning of cooking, and a time remaining until cooking is finished may be displayed (S320).

After cooking begins, the controller 15 may continuously count down an operation time of the drive 18 and determine whether a preset or predetermined manual user operation time point has been reached. That is, the controller 15 may determine whether the elapsed cooking time has reached the preset manual user operation time point. When the elapsed cooking time has not reached the preset manual user operation time point, the controller 15 may continuously output the time remaining until cooking is finished through the time output 210 (S330).

When the elapsed cooking time has reached the preset manual user operation time point, the controller 15 may output an alarm through the speaker 19 so that the user may recognize that the manual user operation time point has been reached. In addition the time output 210 may flicker or the operation instruction output 230 may flicker to allow the user to visually recognize that the manual user operation time point has been reached (S331).

When the alarm that informs the user that the manual user operation time point has been reached is output, the user may open the door 12 to perform the user operation on the food being cooked. The controller 15 may determine whether the door 12 is open (S340).

When the door 12 is open, the controller 15 may determine that the user has recognized that the manual user operation time point has been reached and is performing the user operation, stop outputting the alarm, and stop the drive 18 (S341). When the user closes the door 12 after turning over the food being cooked the controller 15 may confirm, that that door 12 has been closed. The drive 18 may remain stopped until the door 12 is closed to ensure user safety (S350).

After the door 12 is closed the controller 15 may resume operation of the drive 18 and end the user operation mode. Obviously, operation of the drive 18 may also be resumed according to an input of a cooking start signal by the user after the door 12 is closed (S360).

After the alarm that informs the user that the manual user operation time point has been reached is output, the controller 15 may determine whether a time elapsed after the alarm has been output has reached a preset or predetermined amount of alarm output time. In addition, when the time elapsed after the alarm has been output has not reached the preset amount of alarm output time, the controller 15 may continue to output the alarm (S370).

In addition, when the time elapsed after the alarm has been output has reached the preset amount of alarm output time, the controller 15 may stop outputting the alarm. That is, when the user does not recognize that the manual user operation time point has been reached even though the alarm has been output, the alarm may be prevented from being continuously output until the door 12 is open.

Embodiments disclosed herein are directed to a method for controlling a cooker in which, when a separate operation by a user is required during automatic cooking, the user may be informed of a time point at, which the operation has to be performed. Also, embodiments disclosed herein are directed to a method for controlling a cooker in which, when a separate operation by a user is required during cooking, the user may be allowed to recognize, before cooking begins, that an operation by the user is required.

Further, embodiments disclosed herein are directed to a method for controlling a cooker in which, when a user operation time point is reached, an alarm may be output to allow a user to both aurally and visually recognize that the user operation time point has been reached. Furthermore, embodiments disclosed herein are directed to a method for controlling a cooker in which an alarm informing that a user operation time point has been reached may be efficiently ended. Additionally, the embodiments disclosed herein are directed to a method for controlling a cooker in which a user is informed of a time remaining until a time point at which a user operation is required is reached before cooking begins to allow the user to predict the time point at which a user operation is required.

Embodiments disclosed herein provide a method for controlling a cooker. The method may include selecting a menu in which one of a manual cooking mode or an automatic cooking mode is selected and a cooking start signal is input into a control unit, or controller, determining whether a type of dish to be cooked requires a user operation in which, when the automatic cooking mode i selected and input, whether an input type of dish to be cooked requires a manual user operation during cooking is, determined, and performing a user operation mode in which, when it is determined, in the determining of whether a type of dish to be cooked requires a user operation, that the type of dish to be cooked requires the manual user operation, the user is allowed to recognize a time point at which a preset or predetermined user operation has to be performed. The performing of the user operation: mode may include outputting the user operation mode in which letters or drawings informing the user of the user operation mode are output through a display disposed or provided at a main body, after the outputting of the user operation mode, operating a driving unit or drive in which a heat source for cooking is operated, after the operating of the driving unit, determining a manual user operation time in,which whether a driving, unit operation time has reached a preset or predetermined manual user operation time is determined, and when the driving unit operation time has reached the preset manual user operation time, outputting an alarm in which an alarm is output to the user.

The outputting of an alarm may include displaying the manual user operation time through the display when cooking begins. The performing, of a user operation mode may include, when the manual user operation time is reached, outputting letters or drawings that inform the user of the manual user operation time through the display.

The method may further include, when the manual user operation time is reached, further outputting a sound through a speaker disposed or provided at the main body. The outputting of an alarm may end when a door disposed or provided at the main body to open and close a cooking compartment in which food is cooked is open. The outputting of an alarm may end when a set amount of time has elapsed before the door is open.

After the performing of a use operation mode is finished, the control unit may determine whether an entire cooking time has elapsed after the user operation mode is performed and may continue to operate the driving unit when the entire cooking time has not elapsed or stop operating the driving unit when the entire cooking time has elapsed. The outputting of the user operation mode may include outputting a time remaining until the preset manual user operation time for a set amount of time and then outputting the entire cooking time through the display. The time remaining until the preset manual user operation time may be repeatedly lighted and extinguished. The operating of the driving unit may include outputting the entire cooking time through the display and counting down the entire cooking time as the driving unit operation time elapses. The display may output turning over food being cooked or mixing cooking ingredients.

A method for controlling a cooker according to embodiments disclosed herein may have at least the following advantages.

First, when a separate user operation is required during automatic cooking, a user operation may be guided by informing a user of a time point at which the user operation has to be performed. Thus, a quality of cooking may be improved.

Second, when a separate user operation is required during cooking, letters or drawings that inform the user of a user operation mode may be output through a display before cooking beings. Thus, the user may recognize the user operation mode and prepare for a manual user operation.

Third, in outputting an alarm that informs the user that manual user operation time point is reached, a sound may be output through a speaker and letters or drawings that inform the user that the manual user operation time point has been reached may be output through a display. Thus, the user may both aurally and visually recognize that the manual user operation time point has been reached. Consequently, the user may more clearly recognize the manual user operation time point in various use environments and circumstances, and a quality of cooking may be improved by a proper user operation being performed.

Fourth, the letters or drawings that inform the user that the manual user operation time point is reached output through the display may be repeatedly lighted and extinguished. Thus, the user may more clearly recognize that the manual user operation time point has been reached even from a distant location and, may perform a proper user operation.

Fifth, outputting an al m end when a door is, open or a time at which the alarm has been output reaches a preset amount of alarm output time. Thus, the alarm may be prevented from being continuously generated when the user has not recognized the alarm and the alarm may be efficiently operated.

Sixth, in outputting a user operation mode, letters or drawings that inform a user of the user operation mode may be repeatedly lighted and extinguished for a preset amount of time. Thus, the user may more clearly recognize the user operation mode and deal with the user operation mode.

Although embodiments have been described with reference to a number of illustrative embodiments thereof, it will be understood by those skilled in the art that various changes in form and details may be made therein without departing from the spirit and scope as defined by the appended claims. Therefore, the embodiments should be considered in a descriptive sense only and not for purposes of limitation, and also the technical scope is not limited to the embodiments. Further, the embodiments are defined not by the detailed description but by the appended claims, and all differences within the scope will be construed as being comprised in the present disclosure.

Any reference in this specification to “one embodiment,” “an embodiment” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fail within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling a cooker, he method comprising:
receiving via a user input a selection of a menu in which one of a manual cooking mode or an automatic cooking mode is selected and a cooking start signal;
determining via a controller whether a type of dish to be cooked requires a user operation in which, when the automatic cooking mode is selected, whether an input type of dish to be cooked requires a manual user operation during cooking is determined; and
performing via a controller a user operation mode in which, when it is determined, in the determining of whether the type of dish to be cooked requires a user operation, that the type of dish to be cooked requires the manual user operation, the user is informed of a time point at which a predetermined user operation has to be performed.

2. The method of claim 1, wherein the performing of the user operation mode includes:
outputting a user operation mode in which letters or drawings informing the user of the user operation mode are output through a display provided at a main body of the cooker;
after the outputting of the user operation mode, operating via the controller a drive of the cooker for a heat source for cooking;
after the operating of the drive, determining via the controller whether a drive operation time has reached a predetermined manual user operation time; and
when the drive operation time has reached the predetermined manual user operation time, outputting via the controller an alarm to the user.

3. The method of claim 2, wherein the outputting of the alarm includes displaying the manual user operation time through the display when cooking begins.

4. The method of claim 3, wherein the performing of the user operation mode includes, when the manual user operation time is reached, outputting letters or drawings that inform the user of the manual user operation time through the display.

5. The method of claim 4, further including, when the manual user operation time is reached, further outputting a sound through a speaker provided at the main body of the cooker.

6. The method of claim 2, wherein the outputting of the alarm ends when a door provided at the main body to open and close a cooking compartment in which food is cooked is opened.

7. The method of claim 2, wherein the outputting of the alarm ends when a predetermined amount of time has elapsed before the door is opened.

8. The method of claim 2, wherein, after the performing of the user operation mode is finished, the controller determines whether an entire cooking time has elapsed after the, user operation mode is performed and continues to operate the drive when the entire cooking time has not elapsed or stops operating the drive when the entire cooking time has elapsed.

9. The method of claim 2, wherein the outputting of the user operation mode includes outputting a time remaining until the predetermined manual user operation time for a set amount of time and then outputting the entire cooking time through the display.

10. The method of claim 2, wherein the time remaining until the predetermined manual user operation time is repeatedly lit and extinguished.

11. The method of claim 10, wherein the operating of the drive includes outputting the entire cooking time through the display and counting down the entire cooking time as the drive operation time elapses.

12. The method of claim 2, wherein the display outputs the manual user operation of turning over food being cooked or mixing cooking ingredients.

13. A method for controlling a cooker, the method comprising:
receiving a selection via a user input of a type of dish to be cooked in an automatic cooking mode;
determining via a controller whether the type of dish to be cooked requires a manual user operation during cooking; and
performing via a controller a user operation mode in which, when it is determined that the type of dish to be cooked requires the manual user operation, the user is informed of a time point at which the manual user operation has to be performed.

14. The method of claim 13, wherein the performing of the user operation mode includes:
informing the user of the user operation mode through a display provided at a main body of the cooker;
thereafter, operating via the controller a drive of the cooker for a heat source for cooking;
thereafter, determining via the controller whether a drive operation time has reached a predetermined manual user operation time; and
when the drive operation time has reached the predetermined manual user operation time, outputting via the controller an alarm to the user.

15. The method of claim 14, wherein the outputting of the alarm includes displaying the manual user operation time through the display when cooking begins.

16. The method of claim 15, wherein the performing of the user operation mode includes, when the manual user operation time is reached, outputting letters or drawings that inform the user of the manual user operation time through the display.

17. The method of claim 16, further including, when the manual user operation time is reached, further outputting a sound through a speaker provided at the main body of the cooker.

18. The method of claim 14, wherein the outputting of the alarm ends when a door provided at the main body to open and close a cooking compartment in which food is cooked is opened or when a predetermined amount of time has elapsed before the door is opened.

19. The method of claim 14, wherein the operating of the drive includes outputting the entire cooking time through the display and counting down the entire cooking time as the drive operation time elapses.

20. The method of claim 14, wherein the display outputs the manual user operation of turning over food being cooked or mixing cooking ingredients.
